(19) United States
(12) Patent Application Publication
(10) Pub. No.: US 2025/0210049 A1
(43) Pub. Date: Jun. 26, 2025

(54) PARAMETRIC SPATIAL AUDIO ENCODING

(71) Applicant: NOKIA TECHNOLOGIES OY, Espoo (FI)

(72) Inventor: Adriana VASILACHE, Tampere (FI)

(21) Appl. No.: 18/848,328

(22) PCT Filed: Mar. 22, 2022
(86) PCT No.: PCT/EP2022/057502

§ 371 Date: Sep. 18, 2024

(51) Int. Cl. G10L 19/008; G10L 19/002; G10L 19/02

(52) U.S. Cl. CPC G10L 19/008; G10L 19/002; G10L 19/0204

(57) ABSTRACT

An apparatus comprising means for: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

### FIELD

The present application relates to apparatus and methods for spatial audio representation and encoding, but not exclusively for audio representation for an audio encoder.

### BACKGROUND

Immersive audio codecs are being implemented supporting a multitude of operating points ranging from a low bit rate operation to transparency. An example of such a codec is the Immersive Voice and Audio Services (IVAS) codec which is being designed to be suitable for use over a communications network such as a 3GPP 4G/5G network including use in such immersive services as for example immersive voice and audio for virtual reality (VR). This audio codec is expected to handle the encoding, decoding and rendering of speech, music and generic audio. It is furthermore expected to support channel-based audio and scene-based audio inputs including spatial information about the sound field and sound sources. The codec is also expected to operate with low latency to enable conversational services as well as support high error robustness under various transmission conditions.

Metadata-assisted spatial audio (MASA) is one input format proposed for IVAS. It uses audio signal(s) together with corresponding spatial metadata. The spatial metadata comprises parameters which define the spatial aspects of the audio signals and which may contain for example, directions and direct-to-total energy ratios in frequency bands. The MASA stream can, for example, be obtained by capturing spatial audio with microphones of a suitable capture device. For example a mobile device comprising multiple microphones may be configured to capture microphone signals where the set of spatial metadata can be estimated based on the captured microphone signals. The MASA stream can be obtained also from other sources, such as specific spatial audio microphones (such as Ambisonics), studio mixes (for example, a 5.1 audio channel mix) or other content by means of a suitable format conversion.

### SUMMARY

According to a first aspect there is provided an apparatus comprising means for: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

The means for first resolution entropy encoding the at least one directional value and determining the number of bits used encoding the at least one directional value based on the first entropy encoding may be for at least one resolution entropy encoding of at least one value determined from a difference between the at least one directional value compared to an average directional value for the frame and determining a number of bits used encoding the at least one value, and the means for first resolution entropy encoding at least one reduced directional value and determining the number of bits used encoding the at least one reduced directional value based on the first entropy encoding is for at least one resolution entropy encoding of at least one reduced value from a reduced difference based on the difference between the at least one directional value compared to the average directional value for the frame and determining a number of bits used encoding the at least one reduced value.

The means for encoding the at least one directional value for at least one sub-frame of each sub-band of a frame based on at least one resolution entropy encoding may be further for: second resolution entropy encoding at least one value based on the at least one directional value and determining the number of bits used encoding the at least one value based on the second resolution entropy encoding, wherein the second resolution entropy encoding may be a lower resolution encoding than the first resolution entropy encoding and exploits similarities between time-frequency tiles within a sub-band within the frame when the frame comprises more than one time-frequency tile within a sub-band; and selecting the second resolution entropy encoding of the at least one value when the number of bits used encoding the at least one value based on the second resolution entropy encoding is less than or equal to the portion of the allowed number of bits for encoding the at least one directional value.

The at least one value based on the at least one directional value may be at least one difference value from the at least one directional value compared to an average directional value for the frame.

The means may be further for selecting the second resolution entropy encoding of the at least one value based on the at least one directional value when the number of bits used encoding the at least one value based on the second resolution entropy encoding is greater than the portion of the allowed number of bits for encoding the at least one directional value but is less than a determined relaxed number of bits.

The relaxed number of bits may be a number of bits relative to the portion of the allowed number of bits for encoding the at least one directional value.

The means for encoding the at least one directional value for the at least one sub-frame of each sub-band of the frame based on at least one resolution entropy encoding, wherein one of the at least one resolution entropy encoding may be further for: third resolution entropy encoding at least one value based on the at least one directional value and determining the number of bits used encoding the at least one value based on the third resolution entropy encoding, wherein the quantization resolution of the third resolution is lower than the first and second resolution entropy encoding; and selecting the third resolution entropy encoding of the at least one value based on the at least one directional value when the number of bits used encoding the at least one value based on the first or second resolution entropy encoding is more than the portion of the allowed number of bits for encoding the at least one value.

The at least one value based on the at least one directional value may be at least one difference value from the at least one directional value compared to an average directional value for the frame.

The means may be further for encoding the at least one energy ratio value for the at least one sub-frame of each sub-band of the frame of the audio signal.

The means for encoding the at least one energy ratio value for the at least one sub-frame of each sub-band of a frame of the audio signal may be for: generating a weighted average of the at least one energy ratio value; and encoding the weighted average of the at least one energy ratio value.

The means for encoding the weighted average of the at least one energy ratio value may be further for scalar non-uniform quantizing the at least one weighted average of the at least one energy ratio value.

The at least one entropy encoding may be Golomb Rice encoding.

The means for may be further for: storing and/or transmitting the encoded at least one directional value.

According to a second aspect there is provided a method comprising: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

First resolution entropy encoding the at least one directional value and determining the number of bits used encoding the at least one directional value based on the first entropy encoding may comprise at least one resolution entropy encoding of at least one value determined from a difference from the at least one directional value compared to an average directional value for the frame and determining a number of bits used encoding the at least one value, and first resolution entropy encoding at least one reduced directional value and determining the number of bits used encoding the at least one reduced directional value based on the first entropy encoding may comprise at least one resolution entropy encoding of at least one reduced value from a reduced difference based on the difference between the at least one directional value compared to the average directional value for the frame and determining a number of bits used encoding the at least one reduced value.

Encoding the at least one directional value for at least one sub-frame of each sub-band of a frame based on at least one resolution entropy encoding may comprise: second resolution entropy encoding at least one value based on the at least one directional value and determining the number of bits used encoding the at least one value based on the second resolution entropy encoding, wherein the second resolution entropy encoding is a lower resolution encoding than the first resolution entropy encoding and exploits similarities between time-frequency tiles within a sub-band within the frame when the frame comprises more than one time-frequency tile within a sub-band; and selecting the second resolution entropy encoding of the at least one value when the number of bits used encoding the at least one value based on the second resolution entropy encoding is less than or equal to the portion of the allowed number of bits for encoding the at least one directional value.

The at least one directional value may be at least one value based on the at least one directional value may be at least one difference value from the at least one directional value compared to an average directional value for the frame.

The method may further comprise selecting the second resolution entropy encoding of the at least one value based on the at least one directional value when the number of bits used encoding the at least one value based on the second resolution entropy encoding is greater than the portion of the allowed number of bits for encoding the at least one directional value but is less than a determined relaxed number of bits.

The relaxed number of bits may be a number of bits relative to the portion of the allowed number of bits for encoding the at least one directional value.

Encoding the at least one directional value for the at least one sub-frame of each sub-band of the frame based on at least one resolution entropy encoding, wherein one of the at least one resolution entropy encoding may further comprise: third resolution entropy encoding at least one value based on the at least one directional value and determining the number of bits used encoding the at least one value based on the third resolution entropy encoding, wherein the quantization resolution of the third resolution is lower than the first and second resolution entropy encoding; and selecting the third resolution entropy encoding of the at least one value based on the at least one directional value when the number of bits used encoding the at least one value based on the first or second resolution entropy encoding more than the portion of the allowed number of bits for encoding the at least one directional value.

The at least one value may be at least one difference value from the at least one directional value compared to an average directional value for the frame.

The method may further comprise encoding the at least one energy ratio value for the at least one sub-frame of each sub-band of the frame of the audio signal.

Encoding the at least one energy ratio value for the at least one sub-frame of each sub-band of a frame of the audio signal may comprise: generating a weighted average of the at least one energy ratio value; and encoding the weighted average of the at least one energy ratio value.

Encoding the weighted average of the at least one energy ratio value may further comprise scalar non-uniform quantizing the at least one weighted average of the at least one energy ratio value.

The at least one entropy encoding may be a Golomb Rice encoding.

The method may further comprise storing and/or transmitting the encoded at least one directional value.

According to a third aspect there is provided an apparatus comprising: at least one processor and at least one memory including a computer program code, the at least one memory and computer program code configured to, with the at least one processor, cause the apparatus at least to: obtain values for parameters representing an audio signal, the values comprising at least one directional value and at least one energy ratio value for at least one sub-frame of each sub-band of a frame of the audio signal; obtain an allowed number of bits for encoding the at least one directional value and the at least one energy ratio value for the at least one sub-frame of each sub-band of the frame of the audio signal; encode the at least one directional value for the at least one sub-frame of each sub-band of the frame based on at least one resolution entropy encoding, wherein one of the at least one resolution entropy encoding is further caused to: first resolution entropy encode the at least one directional value and determine the number of bits used encoding the at least one directional value based on the first entropy encoding; first resolution entropy encode at least one reduced directional value and determine the number of bits used encoding the at least one reduced directional value based on the first entropy encoding; select the first resolution entropy encoding of the at least one directional value when the number of bits used encoding the at least one directional value based on the first resolution entropy encoding is less than or equal to a portion of the allowed number of bits for encoding the at least one directional value; and select the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

The apparatus caused to first resolution entropy encode the at least one directional value and determine the number of bits used encoding the at least one directional value based on the first entropy encoding may be caused to at least one resolution entropy encode of at least one value determined from a difference between the at least one directional value compared to an average directional value for the frame and determining a number of bits used encoding the at least one value, and the apparatus caused to first resolution entropy encode at least one reduced directional value and determine the number of bits used encoding the at least one reduced directional value based on the first entropy encoding is caused to at least one resolution entropy encode at least one reduced value from a reduced difference based on the difference between the at least one directional value compared to the average directional value for the frame and determining a number of bits used encoding the at least one reduced value.

The apparatus caused to encode the at least one directional value for at least one sub-frame of each sub-band of a frame based on at least one resolution entropy encoding may be further caused to: second resolution entropy encode at least one value based on the at least one directional value and determine the number of bits used encoding the at least one value based on the second resolution entropy encoding, wherein the second resolution entropy encoding is a lower resolution encoding than the first resolution entropy encoding and exploits similarities between time-frequency tiles within a sub-band within the frame when the frame comprises more than one time-frequency tile within a sub-band; and select the second resolution entropy encoding of the at least one value when the number of bits used encoding the at least one value based on the second resolution entropy encoding is less than or equal to the portion of the allowed number of bits for encoding the at least one directional value.

The at least one value based on the at least one directional value may be at least one difference value from the at least one directional value compared to an average directional value for the frame.

The apparatus may be further caused to select the second resolution entropy encoding of the at least one value based on the at least one directional value when the number of bits used encoding the at least one value based on the second resolution entropy encoding is greater than the portion of the allowed number of bits for encoding the at least one directional value but is less than a determined relaxed number of bits.

The relaxed number of bits may be a number of bits relative to the portion of the allowed number of bits for encoding the at least one directional value.

The apparatus caused to encode the at least one directional value for the at least one sub-frame of each sub-band of the frame based on at least one resolution entropy encoding, wherein one of the at least one resolution entropy encoding may be caused to: third resolution entropy encode at least one value based on the at least one directional value and determine the number of bits used encoding the at least one value based on the third resolution entropy encoding, wherein the quantization resolution of the third resolution is lower than the first and second resolution entropy encoding; and select the third resolution entropy encoding of the at least one value based on the at least one directional value when the number of bits used encoding the at least one value based on the first or second resolution entropy encoding is more than the portion of the allowed number of bits for encoding the at least one value.

The at least one value based on the at least one directional value may be at least one difference value from the at least one directional value compared to an average directional value for the frame.

The apparatus may be further caused to encode the at least one energy ratio value for the at least one sub-frame of each sub-band of the frame of the audio signal.

The apparatus caused to encode the at least one energy ratio value for the at least one sub-frame of each sub-band of a frame of the audio signal may be caused to: generate a weighted average of the at least one energy ratio value; and encode the weighted average of the at least one energy ratio value.

The apparatus caused to encode the weighted average of the at least one energy ratio value may be further caused to scalar non-uniform quantize the at least one weighted average of the at least one energy ratio value.

The at least one entropy encoding may be Golomb Rice encoding.

The apparatus may be further caused to: store and/or transmit the encoded at least one directional value.

According to a fourth aspect there is provided an apparatus comprising: obtaining circuitry configured to obtain obtaining values for parameters representing an audio signal, the values comprising at least one directional value and at least one energy ratio value for at least one sub-frame of each sub-band of a frame of the audio signal; obtaining circuitry configured to obtain an allowed number of bits for encoding the at least one directional value and the at least one energy ratio value for the at least one sub-frame of each sub-band of the frame of the audio signal; encoding circuitry configured to encode the at least one directional value for the at least one sub-frame of each sub-band of the frame based on at least one resolution entropy encoding, wherein one of the at least one resolution entropy encoding is: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

According to a fifth aspect there is provided a computer program comprising instructions [or a computer readable medium comprising program instructions] for causing an apparatus to perform at least the following: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

According to a sixth aspect there is provided a non-transitory computer readable medium comprising program instructions for causing an apparatus to perform at least the following: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

According to a seventh aspect there is provided an apparatus comprising: means for obtaining values for parameters representing an audio signal, the values comprising at least one directional value and at least one energy ratio value for at least one sub-frame of each sub-band of a frame of the audio signal; means for obtaining an allowed number of bits for encoding the at least one directional value and the at least one energy ratio value for the at least one sub-frame of each sub-band of the frame of the audio signal; means for encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

According to a eighth aspect there is provided a computer readable medium comprising program instructions for causing an apparatus to perform at least the following: obtaining values for parameters representing an audio signal, the values comprising at least one directional value and at least one energy ratio value for at least one sub-frame of each sub-band of a frame of the audio signal; obtaining an allowed number of bits for encoding the at least one directional value and the at least one energy ratio value for the at least one sub-frame of each sub-band of the frame of the audio signal; encoding the at least one directional value for the at least one sub-frame of each sub-band of the frame based on at least one resolution entropy encoding, wherein one of the at least one resolution entropy encoding is further for: first resolution entropy encoding the at least one directional value and determining the number of bits used encoding the at least one directional value based on the first entropy encoding; first resolution entropy encoding at least one reduced directional value and determining the number of bits used encoding the at least one reduced directional value based on the first entropy encoding; selecting the first resolution entropy encoding of the at least one directional value when the number of bits used encoding the at least one directional value based on the first resolution entropy encoding is less than or equal to a portion of the allowed number of bits for encoding the at least one directional value; and selecting the first resolution entropy encoding of the at least one reduced directional value when the number of bits used encoding the at least one directional value based on the first resolution entropy encoding is more than to the portion of the allowed number of bits for encoding the at least one directional value and the number of bits used encoding the at least one directional value based on the first resolution entropy encoding is less than or equal to the portion of the allowed number of bits for encoding the at least one directional value.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically a decoder as shown in the system of apparatus as shown in FIG. 1 according to some embodiments;

FIG. 3 shows a flow diagram of the operation of the example decoder shown in FIG. 2 according to some embodiments;

FIG. 4 shows schematically an example synthesis processor as shown in FIG. 2 according to some embodiments;

FIG. 5 shows a flow diagram of the operation of the example synthesis processor as shown in FIG. 4 according to some embodiments; and

FIG. 6 shows an example device suitable for implementing the apparatus shown in previous figures.

### EMBODIMENTS OF THE APPLICATION

The following describes in further detail suitable apparatus and possible mechanisms for the encoding of parametric spatial audio streams comprising transport audio signals and spatial metadata.

As discussed above Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound source directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example a reasonable design choice which is able to produce a good quality output is one where the spatial metadata comprises one or more directions for each time-frequency subframe (and associated with each direction direct-to-total ratios, spread coherence, distance values etc) are determined.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

At very low bit rates (e.g., around 13.2-16.4 kbps), there are very few bits available for coding the metadata. For example only about 3 kbps may be used for the coding of the metadata to obtain sufficient bitrate for the audio signal codec.

To have sufficient frequency and temporal resolution (for example having 5 frequency bands and having 20 milliseconds temporal resolution), in many cases only a few bits can be used per value (e.g., the direction parameter). In practice, this means that the quantization steps are relatively large. Thus, for example, for a certain time-frequency tile the quantization points are at 0, 45, 90, 135, and 180 degrees of azimuth.

Dynamic resolution (or dynamic quantization resolution) can be implemented to attempt to improve the resultant encoder output. For example as described in GB1811071.8 an entropy coder is implemented where the angle resolution is provided by the energy ratio of each subband. If the resulting number of bits is higher than the maximum allowed number of bits, the quantization resolution is reduced and an entropy coder such as described in EP3861548 is used. However, the quantization resolution reduction can be too high for some frames as the directional resolution of the human hearing is about 1-2 degrees in the azimuth direction, and any azimuth jumps from, for example 0 to 45 degrees can be easily perceived, and clearly lower the audio quality, making the reproduction unnatural.

The concept as discussed in the embodiments herein attempts to counteract the loss of angle resolution. In some embodiments the maximum number of bits allowed limit is relaxed. Furthermore in some embodiments a check is made whether a slightly less precise quantization of the angles can be realized within the entropy coder by implementing a pseudo-embedded bitstream. In some embodiments the quantization is further modified in situations where the input spatial metadata has only 1 subframe subband.

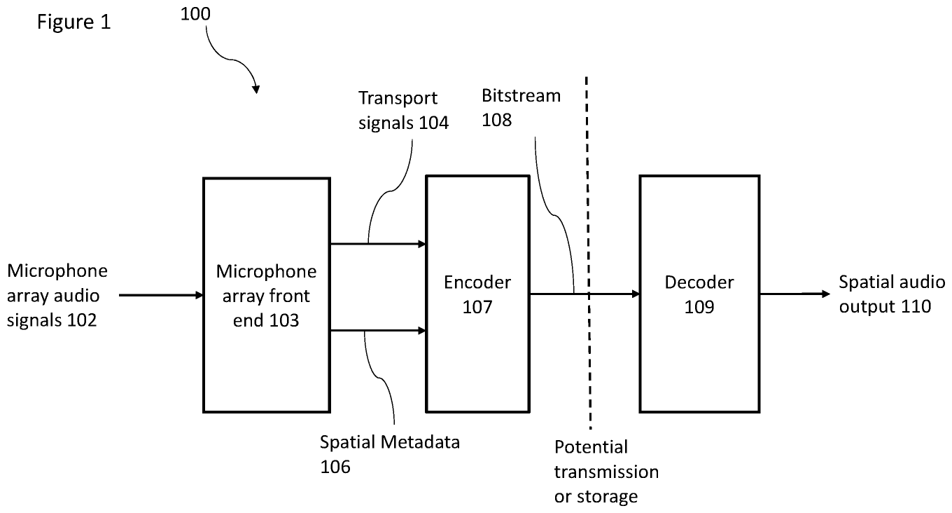

Embodiments will be described with respect to an example capture (or encoder/analyser) and playback (or decoder/synthesizer) apparatus or system 100 as shown in FIG. 1. In the following example the audio signal input is one from a microphone array, however it would be appreciated that the audio input can be any suitable audio input format and the description hereafter details, where differences in the processing occurs when a differing input format is employed.

The system 100 is shown with capture part and a playback (decoder/synthesizer) part.

The capture part in some embodiments comprises a microphone array audio signals input 102. The input audio signals can be from any suitable source, for example: two or more microphones mounted on a mobile phone, other microphone arrays, e.g., B-format microphone or Eigenmike. In some embodiments, as mentioned above, the input can be any suitable audio signal input such as Ambisonic signals, e.g., first-order Ambisonics (FOA), higher-order Ambisonics (HOA) or Loudspeaker surround mix and/or objects.

The microphone array audio signals input 102 may be provided to a microphone array front end 103. The microphone array front end in some embodiments is configured to implement an analysis processor functionality configured to generate or determine suitable (spatial) metadata associated with the audio signals and implement a suitable transport signal generator functionality to generate transport audio signals.

The analysis processor functionality is thus configured to perform spatial analysis on the input audio signals yielding suitable spatial metadata 106 in frequency bands. For all of the aforementioned input types, there exists known methods to generate suitable spatial metadata, for example directions and direct-to-total energy ratios (or similar parameters such as diffuseness, i.e., ambient-to-total ratios) in frequency bands. These methods are not detailed herein, however, some examples may comprise the performing of a suitable time-frequency transform for the input signals, and then in frequency bands when the input is a mobile phone microphone array, estimating delay-values between microphone pairs that maximize the inter-microphone correlation, and formulating the corresponding direction value to that delay (as described in GB Patent Application Number 1619573.7 and PCT Patent Application Number PCT/F12017/050778), and formulating a ratio parameter based on the correlation value. The direct-to-total energy ratio parameter for multi-channel captured microphone array signals can be estimated based on the normalized cross-correlation parameter cor′(k,n) between a microphone pair at band k, the value of the cross-correlation parameter lies between −1 and 1. A direct-to-total energy ratio parameter r(k,n) can be determined by comparing the normalized cross-correlation parameter to a diffuse field normalized cross correlation parameter cor′_{D}(k,n) as

$$r ( k , n ) = \frac{{cor}^{′} ( k , n ) - {cor}_{D}^{′} ( k , n )}{1 - {cor}_{D}^{′} ( k , n )} .$$

The direct-to-total energy ratio is explained further in PCT publication WO2017/005978 which is incorporated herein by reference.

The metadata can be of various forms and in some embodiments comprise spatial metadata and other metadata. A typical parameterization for the spatial metadata is one direction parameter in each frequency band characterized as an azimuth value ϕ(k,n) value and elevation value θ(k,n) and an associated direct-to-total energy ratio in each frequency band r(k,n), where k is the frequency band index and n is the temporal frame index.

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons.

In some embodiments when the audio input is a FOA signal or B-format microphone the analysis processor functionality can be configured to determine parameters such as an intensity vector, based on which the direction parameter is obtained, and to compare the intensity vector length to the overall sound field energy estimate to determine the ratio parameter. This method is known in the literature as Directional Audio Coding (DirAC).

In some embodiments when the input is HOA signal, the analysis processor functionality may either take the FOA subset of the signals and use the method above, or divide the HOA signal into multiple sectors, in each of which the method above is utilized. This sector-based method is known in the literature as higher order DirAC (HO-DirAC). In this case, there is more than one simultaneous direction parameter per frequency band.

In some embodiments when the input format is a loudspeaker surround mix and/or objects, the analysis processor functionality may be configured to convert the signal into a FOA signal(s) (via use of spherical harmonic encoding gains) and to analyse direction and ratio parameters as above.

As such the output of the analysis processor functionality is (spatial) metadata 106 determined in frequency bands. The (spatial) metadata 106 may involve directions and energy ratios in frequency bands but may also have any of the metadata types listed previously. The (spatial) metadata 106 can vary over time and over frequency.

In some embodiments the analysis functionality is implemented external to the system 100. For example, in some embodiments the spatial metadata associated with the input audio signals may be provided to an encoder 107 as a separate bit-stream. In some embodiments the spatial metadata may be provided as a set of spatial (direction) index values.

The microphone array front end 103, as described above is further configured to implement transport signal generator functionality, in order to, generate suitable transport audio signals 104. The transport signal generator functionality 113 is configured to receive the input audio signals, which may for example be the microphone array audio signals 103 and generate the transport audio signals 104. The transport audio signals may be a multi-channel, stereo, binaural or mono audio signal. The generation of transport audio signals 104 can be implemented using any suitable method such as summarised below.

When the input is microphone array audio signals, the transport signal generator functionality may be selecting a left-right microphone pair, and applying suitable processing to the signal pair, such as automatic gain control, microphone noise removal, wind noise removal, and equalization.

When the input is a FOA/HOA signal or B-format microphone, the transport signals 104 may be directional beam signals towards left and right directions, such as two opposing cardioid signals.

When the input is loudspeaker surround mix and/or objects, the transport signals 104 may be a downmix signal that combines left side channels to left downmix channel, and same for right side, and adds centre channels to both transport channels with a suitable gain.

In some embodiments the transport signals 104 are the input audio signals, for example the microphone array audio signals. For example, in some situations, where the analysis and synthesis occur at the same device at a single processing step, without intermediate encoding. The number of transport channels can also be any suitable number (rather than one or two channels as discussed in the examples).

In some embodiments the capture part may comprise an encoder 107. The encoder 107 can be configured to receive the transport audio signals 104 and the spatial metadata 106. The encoder 107 may furthermore be configured to generate a bitstream 108 comprising an encoded or compressed form of the metadata information and transport audio signals.

The encoder 107, for example, could be implemented as an IVAS encoder, or any other suitable encoder. The encoder 107, in such embodiments is configured to encode the audio signals and the metadata and form an IVAS bit stream.

This bitstream 108 may then be transmitted/stored as shown by the dashed line.

The system 100 furthermore may comprise a decoder 109 part. The decoder 109 is configured to receive, retrieve, or otherwise obtain the bitstream 108 and from the bitstream generate suitable spatial audio signals 110 to be presented to the listener/listener playback apparatus.

The decoder 109 is therefore configured to receive the bitstream 108 and demultiplex the encoded streams and then decode the audio signals to obtain the transport signals and metadata.

The decoder 109 furthermore can be configured to, from the transport audio signals and the spatial metadata, produce the spatial audio signals output 110 for example a binaural audio signal that can be reproduced over headphones.

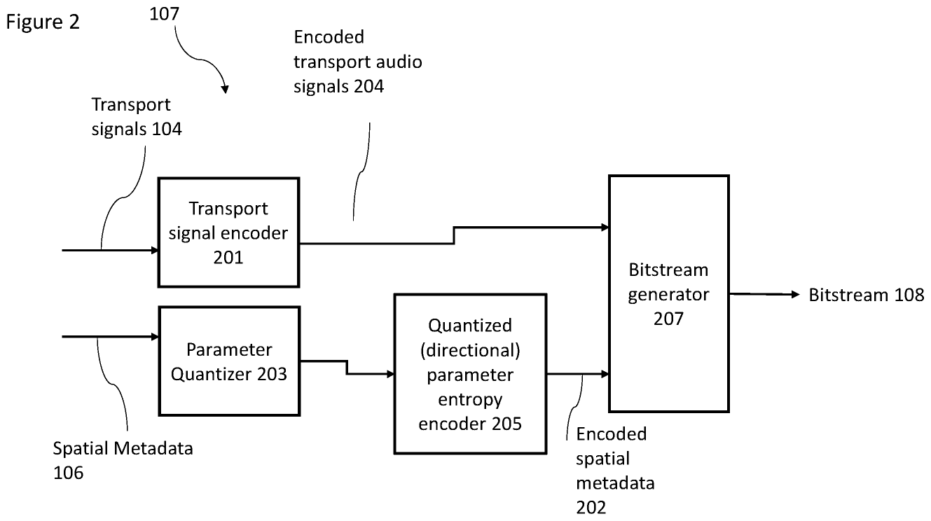

With reference to FIG. 2, a schematic example of an encoder 107 is shown in further detail.

The encoder 107 is shown in FIG. 2 with the transport signals 104 being input to a transport signal encoder 201. The transport signal encoder 201 can be any suitable audio signal encoder. For example an Enhanced Voice Services (EVS) or Immersive Voice and Audio Services (IVAS) stereo core encoder implementation can be applied to the transport (audio) signals to generate suitable encoded transport audio signals 204 which can be passed to a bitstream generator 207 or output as a separate bitstream to the spatial metadata parameters.

The encoder 107 in some embodiments is configured to receive the spatial metadata 106 or spatial parameters and pass these to a parameter quantizer 203. For example the determined direction parameters (azimuth and elevation or other co-ordinate systems) can be quantized by the parameter quantizer 203 and indices identifying the quantized value passed to the quantized parameter entropy encoder 205.

The encoder 107 in some embodiments further comprises a quantized parameter entropy encoder 205 configured to obtain or receive the quantized parameters and encode them to generate encoded spatial metadata 202 which can be passed to the bitstream generator 207.

The encoder 107 furthermore in some embodiments comprises a bitstream generator 207 which is configured to obtain or receive the encoded transport audio signals 204 and the encoded spatial metadata 202 comprising spread and surround coherence parameters and generate the bitstream 108 or separate bitstreams.

In the following examples the encoder 107 is configured to encode the spatial audio parameters (MASA), in other words the spatial metadata 106. For example, the direction values (azimuth and elevation values ϕ(k,n) and θ(k,n)) may be first quantized according to a spherical quantization scheme. Such a scheme can be found in the patent publication EP3707706. As described above, each type of spatial audio parameter is first quantized in order to obtain a quantization index.

The resulting quantization indices for the spatial audio parameters (e.g. MASA parameters) can then be entropy encoded at differing coding rates in response to a factor stipulating the number of bits of bits allocated for the task. The codec can furthermore use a number of different coding rates and apply this to the encoding of the indices of the spatial audio parameters.

Thus, examples which can be returned to in the following, the audio metadata comprises azimuth, elevation, and energy ratio data for each subband. The audio metadata can also comprise spread and surround coherence, but are encoded first and the remaining available number of bits are calculated by subtracting the coherence bits from the total number of bits.

In the MASA format the directional data is represented on 16 bits such that the azimuth is approximately represented on 9 bits, and the elevation on 7 bits. The energy ratio is represented on 8 bits. For each frame there are between N=5 and M=4 time blocks, and therefore (16+8)×M×N bits are needed to store the uncompressed metadata for each frame. In higher frequency resolutions, there could be 20 or 24 frequency subbands.

In the following example the encoder and decoder operates with N=5 time blocks but in other examples the number of time blocks, bits used and subbands and parameters can differ.

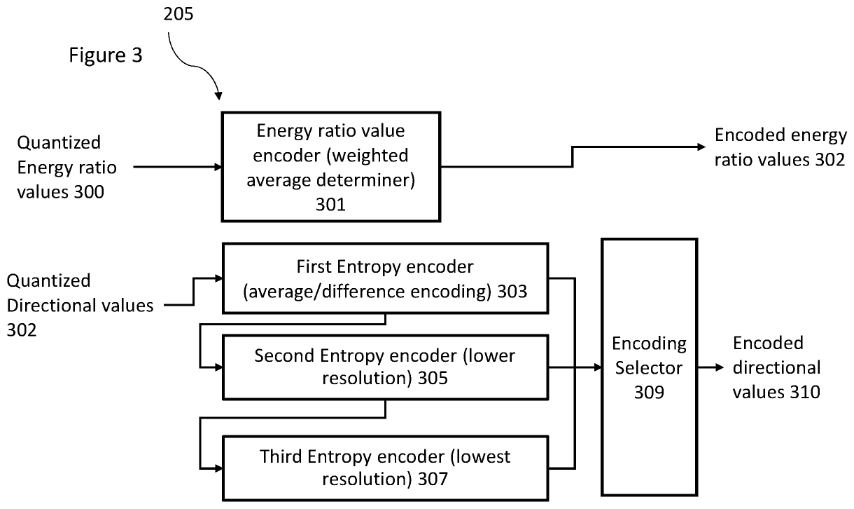

With respect to FIG. 3 is shown an example quantized parameter entropy encoder 205. The quantized parameter entropy encoder 205 in some embodiments comprises an energy ratio value encoder 301. The energy ratio value encoder 301 is configured to receive the quantized energy ratio values 300 and generate encoded energy ratio values 302. In some examples 3 bits are used to encode each energy ratio value. In addition, instead of transmitting all energy ratio values for all TF blocks, only one weighted average value per subband is transmitted. The average is computed by taking into account the total energy of each time block, favouring thus the values of the subbands having more energy.

In some embodiments example quantized entropy encoder comprises more than one entropy encoder configured to receive the quantized directional values 302. In this example there is shown a first directional (average/difference) entropy encoder 303, a second, lower resolution, entropy encoder 305 and a third, lowest resolution average/difference, entropy encoder 307. The first directional (average/difference) entropy encoder 303 (EC1), second, lower resolution, entropy encoder 305 (EC2) and third, lowest resolution, entropy encoder 307 (EC3) are configured to receive the quantized directional values and generate encoded values which are passed to an encoding selector 309.

The example quantized entropy encoder in some embodiments comprises an encoding selector 309 which receives the output of the first, second, and third entropy encoders and selects one of these to output as the encoded directional values 310. The selection can in some embodiments be based on the number of bits generated by each of the encoders and an allowed number of bits such as described in the following encoding of the index values of the direction parameters for all TF tiles in a frame.

In the arrangement shown in FIG. 3 the first, second and third entropy encoders are chained or connected in series such that as described in further detail the first entropy encoder 303 is operated first and when the first entropy encoder 303 fails to encode the parameters in an acceptable manner then the second entropy encoder 305 is operated or activated. Similarly when the second entropy encoder 305 fails to encode the parameters in an acceptable manner then the third entropy encoder 307 is operated or activated. The encoding selector is then configured to select the output of the encoder which is received the last or selected based on an ordering such as third encoder/second encoder/first encoder.

However in some embodiments all three encoders are operated in parallel or substantially in parallel and then one of the three encoder outputs selected by the encoding selector based on which output is acceptable. In such embodiments the first encoder output is checked and if acceptable output, otherwise the second encoder output is checked and if acceptable output otherwise the third encoder output is output.

The encoder selector or encoder operation can for example be implemented or perform an encoding selection based on the following pseudocode.

Input: indices of quantized directional parameters (azimuth and elevation) and allowed number of bits B_{allowed}

| | |
|---|---|
| 1. | Use EC1 for encoding the parameters |
| 2. | If bits_EC1 < B_{allowed} |

| | |
|---|---|
| a. | Encode with EC1 |

| | |
|---|---|
| 3. | Else |

| | |
|---|---|
| a. | Use bandwise encoding EC2 (with a potential |
| | quantization resolution decrease) |
| b. | If bits_EC2 < B_{allowed} |

| | |
|---|---|
| i. | Encode using EC2 |

| | |
|---|---|
| c. | Else |

| | |
|---|---|
| i. | Reduce quantization resolution |
| ii. | Use EC3 |

| | |
|---|---|
| d. | End if |

| | |
|---|---|
| 4. | End if |

In the above the first directional (average/difference) entropy encoder 303 (EC1) corresponds to a first entropy encoding scheme in which the azimuth and elevation indices can be separately encoded. In some embodiments the scheme uses an optimized fixed value average index which is subtracted from each index resulting in a difference index for each direction index. Each resulting difference index may then be transformed to a positive value and then be entropy encoded using a Golomb Rice scheme. The optimized average index may also be entropy encoded for transmission to the decoder. In some embodiments furthermore the directional entropy encoder is based on a time averaged directional value and the difference from the time averaged directional value. For example the difference index value is the difference between a current directional azimuth or elevation value and previous frame or sub-frame averaged or azimuth or elevation value or in some embodiments a difference based on a reference azimuth or elevation value. In some embodiments the value of the average (the number that is subtracted) is chosen such that the resulting number of bits for encoding is minimized. Thus, in some examples, the apparatus tests the value given by the average and also test variants (for instance average and +/−1 values or more values) around the average value and selects the value which produces the smallest number of encoded bits to be sent to the decoder as the “average value”.

The second entropy encoder 305 (EC2) corresponds to a second entropy encoding scheme, which encodes the difference indices with less or lower resolution than EC1. Details of a suitable second entropy encoding scheme may be found in the patent publication WO2021/048468.

The third entropy encoder 307 (EC3) corresponds to a third entropy encoding scheme, which encodes the difference indices with a resolution which is less than EC2. In this respect EC3 may constitute the lowest resolution quantisation scheme in the above general framework. Details of a scheme suitable for use may be found in the patent publication EP3861548.

It can be seen from the above general framework that the choice of encoding rate (and therefore encoding scheme) may be determined in part by a parameter B_{allowed} indicating the number of bits allowed for the encoding of the direction indices for the frame. B_{allowed} may be an encoding system determined parameter in accordance with the overall operating point/bit rate of the encoder for a particular time frame.

As seen from above the parameter B_{allowed} can be used to determine an entropy coding scheme by essentially checking whether the bits required for an entropy encoding scheme is less than the parameter B_{allowed}. This checking process is performed in a decreasing order of bits required for an entropy encoding scheme. The result of the checking process is that the highest order (of encoding bits) entropy encoding scheme is chosen which satisfies the constraint of B_{allowed}.

For example, if the number of bits (bits_EC1) required for the first entropy encoded scheme EC1 is less than B_{allowed}, then the first entropy encoded scheme is used. However, if it is determined that the bits required for EC1 is greater than the constraint B_{allowed} then the number of bits (bits_EC2) required for the second entropy encoded scheme EC2 is checked against B_{allowed}. Furthermore in some embodiments, the second entropy encoded scheme, EC2 is tested only for non-2D cases (i.e. when the elevation is non zero over all tiles in the frame). If this second check indicates that the bits required for EC2 is less than B_{allowed} then the second entropy encoded scheme EC2 is used to entropy encode the direction indices for the frame. However, if the second check indicates that the bits required for EC2 is greater than (or equal) to B_{allowed} then the third entropy encoded scheme EC3 is chosen to encode the direction indices.

The above general framework can be expanded for any number of encoding rates, where each entropy encoding scheme is chosen in accordance the number of bits required (bits_ECn) and bits allowed B_{allowed}

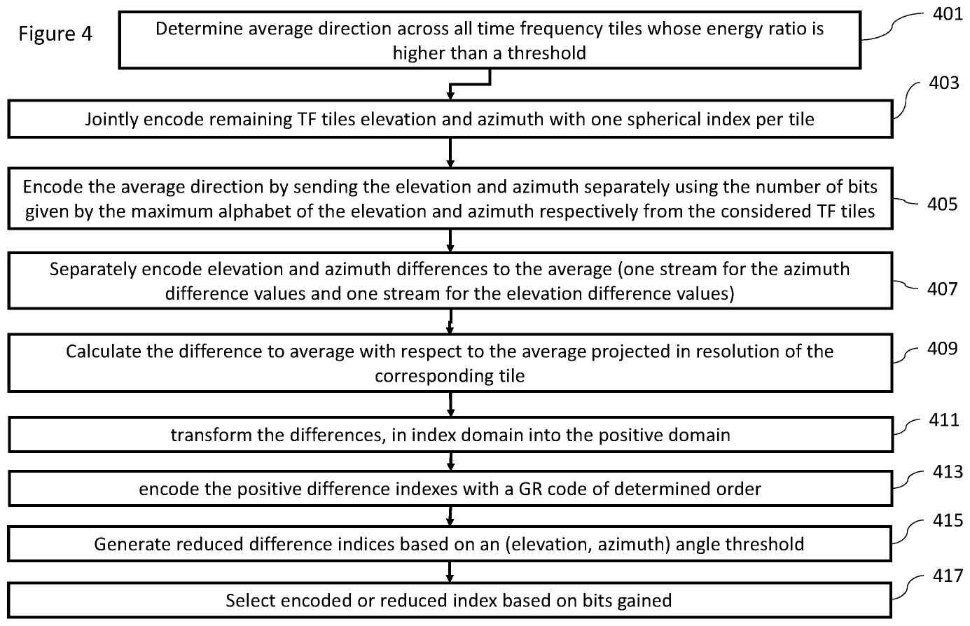

With respect to FIG. 4 is shown the method or operations implemented by the first entropy encoder (EC1) according to some embodiments. In this example the first entropy encoder is configured to perform entropy encoding (EC1) of the directions being encoded in a pseudo-embedded manner.

Thus for example the average direction across all time frequency tiles whose energy ratio is higher than a threshold is calculated as shown in FIG. 4 by step 401.

The remaining TF tiles are then encoded jointly the elevation and azimuth with one spherical index per tile as shown in FIG. 4 by step 403.

The average direction is then encoded by sending the elevation and azimuth separately. This uses the number of bits given by the maximum alphabet of the elevation and azimuth respectively from the considered TF tiles as shown in FIG. 4 by step 405.

The elevation and azimuth differences to the average are separately encoded. In these embodiments one stream for the azimuth difference values and one stream for the elevation difference values as shown in FIG. 4 by step 407.

Then for each angle value, the difference to average is calculated with respect to the average projected in resolution of the corresponding tile as shown in FIG. 4 by step 409.

Then as shown in FIG. 4 by step 411 a transform of the differences to average, in index domain into the positive domain using the following function:

```
for (i = 0; i < len; i++)
{
  if (dif_idx[i] < 0)
  {
    dif_idx[i] = −2 * dif_idx[i];
  }
  else if (dif_idx[i] > 0)
  {
    dif_idx[i] = dif_idx[i] * 2 − 1;
  }
  else
  {
    dif_idx[i] = 0;
  }
}
```

Then encode the positive difference indexes with a GR code of (optimal) determined order. The determined (optimal) GR order is calculated on each data set, one GR order value for the azimuth difference indexes and one GR order value for the elevation difference indexes.

As the GR codes are longer for higher values and shorter for smaller values, it means that if for a difference index if the encoder uses a value smaller with two units, the difference to the average will be of the same sign, but smaller and the number of bits needed for encoding will be smaller as well.

Thus in some embodiments a reduced difference index encoding is generated and furthermore it is determined how many bits can be gained by reducing some of the difference indexes. This is shown in FIG. 4 by step 415.

Then either the encoded indices or reduced difference encoded indices are selected based on the number of bits that have been gained as shown in FIG. 4 by step 417. For example if the first entropy encoder (EC1) produces an encoding with a resulting number of bits higher than the allowed number of bit by a value NB and the maximum number of bits that can be gained is higher than NB, then the reduced difference index value is selected. If neither the encoded or reduced encoding by the first entropy encoder are able to obtain the required number of bits the second entropy encoder EC2 or third entropy encoder EC3 methods are used.

The condition for checking if a difference index can be reduced is that the difference has to be higher than 0 and the angle resolution higher than a given threshold. The angle resolution can in some embodiments be given by the alphabet length of the angle value. In an example 20 degrees can be used as a minimum threshold for the elevation alphabet and 40 degrees as a minimum threshold for the azimuth alphabet. In some embodiments part corresponding to the elevation can be applied only if the azimuth alphabet is adjusted based on the modified elevation value. In some implementations the modifications for the elevation are not used. However ff the values were used, then, when checking the azimuth, the azimuth alphabet should be updated, and the original value requantized.

An example implementation in a C language to determine the number of bits that can be gained can be as follows:

```
    if ( nbands > 1 && direction_bits_ec − max_bits > 0 &&
direction_bits_ec − max_bits < nblocks * nbands )
    {
      /* check how many bits can be gained */
      for ( idx = 0; idx < dist_count; idx++ )
      {
        if ( q_direction->not_in_2D > 0 )
        {
          if ( dist_elevation_alphabets[idx] > 20 &&
dist_elevation_indexes_best[idx] > 1 )
          {
            bits_gained +=
ivas_qmetadata_encode_extended_gr_length(
dist_elevation_indexes_best[idx], dist_elevation_alphabets[idx],
gr_param_elevation_best ) -
ivas_qmetadata_encode_extended_gr_length(
dist_elevation_indexes_best[idx] − 2,
dist_elevation_alphabets[idx], gr_param_elevation_best );
          }
          else if ( dist_elevation_alphabets[idx] > 20
&& dist_elevation_indexes_best[idx] == 1 )
          {
            bits_gained +=
ivas_qmetadata_encode_extended_gr_length(
dist_elevation_indexes_best[idx], dist_elevation_alphabets[idx],
gr_param_elevation_best ) -
ivas_qmetadata_encode_extended_gr_length(
dist_elevation_indexes_best[idx] − 1,
dist_elevation_alphabets[idx], gr_param_elevation_best );
          }
        }
      }
      for ( idx = 0; idx < dist_count; idx++ )
      {
        if ( dist_azimuth_alphabets[idx] > 40 &&
dist_azimuth_indexes_best[idx] > 1 )
        {
          bits_gained +=
ivas_qmetadata_encode_extended_gr_length(
dist_azimuth_indexes_best[idx], dist_azimuth_alphabets[idx],
gr_param_azimuth_best ) -
ivas_qmetadata_encode_extended_gr_length(
dist_azimuth_indexes_best[idx] − 2, dist_azimuth_alphabets[idx],
gr_param_azimuth_best );
        }
        else
        if ( dist_azimuth_alphabets[idx] > 40 &&
dist_azimuth_indexes_best[idx] == 1 )
        {
          bits_gained +=
ivas_qmetadata_encode_extended_gr_length(
dist_azimuth_indexes_best[idx], dist_azimuth_alphabets[idx],
gr_param_azimuth_best ) -
ivas_qmetadata_encode_extended_gr_length(
dist_azimuth_indexes_best[idx] − 1, dist_azimuth_alphabets[idx],
gr_param_azimuth_best );
        }
      }
      printf( “frame = %ld bits_gained = %d %d \n”, frame,
bits_gained, direction_bits_ec − max_bits );
      if ( bits_gained >= direction_bits_ec − max_bits )
      {
        make_gain = 1;
  }
```

In some embodiments the maximum number of bits limit when reducing the quantization resolution can be relaxed. For example before the third entropy encoder (EC3) method is implemented and the number of bits that need to be reduced is limited to at most the number of TF tiles for which the encoding is done. The result of implementing such a relaxation of the bit limit is that for some frames the bit consumption might be more than the maximum bits allowed for the metadata. However the encoding is configured to handle such situations as the encoder generally operates below the required bit limit and thus on average the number of bits used can be relaxed without over a reasonable period the total number of bits being exceeded.

In some embodiments when the encoder determines that there is only one subframe per subband in the input spatial audio data then the second entropy encoder is disabled or deactivated and the second entropy encoding (EC2) method not considered and not signalled. The disabling/deactivation of the second entropy encoder is because the method used in the second entropy encoder is one where similarities between the TF tiles within a subband are examined and exploited, but for this case there is only one tile per subband and thus no similarities will exist.

These embodiments can be implemented for lower bitrates.

The decoder 109 in some embodiments comprises a demultiplexer (not shown) configured to accept and demultiplex the bitstream to obtain the encoded transport audio signals and the encoded spatial audio parameters metadata (MASA metadata) which comprise encoded energy ratio values 302 and encoded directional values 310.

In some embodiments the decoder 109 further comprises a transport audio signal decoder (not shown) which is configured to decode the encoded transport audio signals thereby producing the transport audio signal stream which is passed to a spatial synthesizer. The decoding process performed by the transport audio signal decoder may be a suitable audio signal decoding scheme for the encoded transport audio signals, such as an EVS decoder when EVS encoding is used.

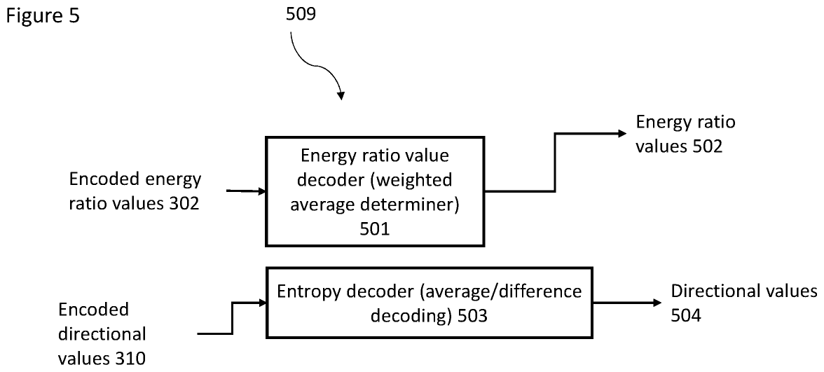

FIG. 5 shows in further details metadata decoder 509 which is configured to accept the encoded spatial metadata (encoded energy ratio values 302 and encoded directional values 310) and decode the metadata to produce the decoded spatial metadata (energy ratio values 502 and directional values or indices 504).

In some embodiments the metadata decoder 509 comprises an energy ration value decoder 501 configured to receive the encoded energy ratio values 302 and based on the values determining the energy ratio values.

The metadata decoder 509 furthermore comprises an entropy decoder 503 configured to obtain the encoded directional values 310 and output directional values 504.

In the above the difference is determined with respect to the other direction values within the sub-frame or frame. However in some embodiments the difference can be determined with respect to the past sub-frames. In other words the average can be determined within the current sub-frame, the current frame or over several time frames.

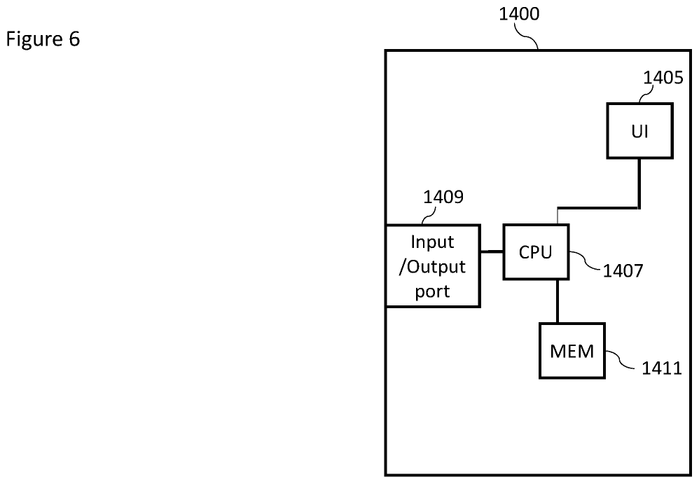

With respect to FIG. 6 an example electronic device which may be used as any of the apparatus parts of the system as described above. The device may be any suitable electronics device or apparatus. For example, in some embodiments the device 1400 is a mobile device, user equipment, tablet computer, computer, audio playback apparatus, etc. The device may for example be configured to implement the encoder/analyser part and/or the decoder part as shown in FIG. 1 or any functional block as described above.

In some embodiments the device 1400 comprises at least one processor or central processing unit 1407. The processor 1407 can be configured to execute various program codes such as the methods such as described herein.

In some embodiments the device 1400 comprises at least one memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The transceiver input/output port 1409 may be configured to receive the signals.

In some embodiments the device 1400 may be employed as at least part of the synthesis device. The input/output port 1409 may be coupled to headphones (which may be a headtracked or a non-tracked headphones) or similar and loudspeakers.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising at least one processor and at least one memory storing instructions that, when executed by the at least one processor, cause the apparatus at least to perform:
obtaining values for parameters representing an audio signal, the values comprising at least one directional value and at least one energy ratio value for at least one sub-frame of each sub-band of a frame of the audio signal;
obtaining an allowed number of bits for encoding the at least one directional value and the at least one energy ratio value for the at least one sub-frame of each sub-band of the frame of the audio signal;
encoding the at least one directional value for the at least one sub-frame of each sub-band of the frame based on at least one resolution entropy encoding, wherein one of the at least one resolution entropy encoding is further for:
first resolution entropy encoding the at least one directional value and determining the number of bits used encoding the at least one directional value based on the first entropy encoding;
first resolution entropy encoding at least one reduced directional value and determining the number of bits used encoding the at least one reduced directional value based on the first entropy encoding;
selecting the first resolution entropy encoding of the at least one directional value when the number of bits used encoding the at least one directional value based on the first resolution entropy encoding is less than or equal to a portion of the allowed number of bits for encoding the at least one directional value; and
selecting the first resolution entropy encoding of the at least one reduced directional value when the number of bits used encoding the at least one directional value based on the first resolution entropy encoding is more than the portion of the allowed number of bits for encoding the at least one directional value and the number of bits used encoding the at least one directional value based on the first resolution entropy encoding is less than or equal to the portion of the allowed number of bits for encoding the at least one directional value.

2. The apparatus as claimed in claim 1, wherein
the apparatus caused to perform first resolution entropy encoding the at least one directional value and determining the number of bits used encoding the at least one directional value based on the first entropy encoding is caused to perform at least one resolution entropy encoding of at least one value determined from a difference between the at least one directional value compared to an average directional value for the frame and determining a number of bits used encoding the at least one value, and
the apparatus caused to perform first resolution entropy encoding at least one reduced directional value and determining the number of bits used encoding the at least one reduced directional value based on the first entropy encoding is caused to perform at least one resolution entropy encoding of at least one reduced value from a reduced difference based on the difference between the at least one directional value compared to the average directional value for the frame and determining a number of bits used encoding the at least one reduced value.

3. The apparatus as claimed in claim 1, wherein the apparatus caused to perform encoding the at least one directional value for at least one sub-frame of each sub-band of a frame based on at least one resolution entropy encoding is further caused to perform:
second resolution entropy encoding at least one value based on the at least one directional value and determining the number of bits used encoding the at least one value based on the second resolution entropy encoding, wherein the second resolution entropy encoding is a lower resolution encoding than the first resolution entropy encoding and exploits similarities between time-frequency tiles within a sub-band within the frame when the frame comprises more than one time-frequency tile within a sub-band; and
selecting the second resolution entropy encoding of the at least one value when the number of bits used encoding the at least one value based on the second resolution entropy encoding is less than or equal to the portion of the allowed number of bits for encoding the at least one directional value.

4. The apparatus as claimed in claim 3, wherein the at least one value based on the at least one directional value is at least one difference value from the at least one directional value compared to an average directional value for the frame.

5. The apparatus as claimed in claim 3, wherein the apparatus is caused to further perform selecting the second resolution entropy encoding of the at least one value based on the at least one directional value when the number of bits used encoding the at least one value based on the second resolution entropy encoding is greater than the portion of the allowed number of bits for encoding the at least one directional value but is less than a determined relaxed number of bits.

6. The apparatus as claimed in claim 5, wherein the relaxed number of bits is a number of bits relative to the portion of the allowed number of bits for encoding the at least one directional value.

7. The apparatus as claimed in claim 5, wherein the apparatus caused to perform encoding the at least one directional value for the at least one sub-frame of each sub-band of the frame based on at least one resolution entropy encoding, wherein one of the at least one resolution entropy encoding is further caused to perform:
third resolution entropy encoding at least one value based on the at least one directional value and determining the number of bits used encoding the at least one value based on the third resolution entropy encoding, wherein the quantization resolution of the third resolution is lower than the first and second resolution entropy encoding; and
selecting the third resolution entropy encoding of the at least one value based on the at least one directional value when the number of bits used encoding the at least one value based on the first or second resolution entropy encoding is more than the portion of the allowed number of bits for encoding the at least one value.

8. The apparatus as claimed in claim 7, wherein the at least one value based on the at least one directional value is at least one difference value from the at least one directional value compared to an average directional value for the frame.

9. The apparatus as claimed in claim 1, wherein the apparatus is caused to further perform encoding the at least one energy ratio value for the at least one sub-frame of each sub-band of the frame of the audio signal.

10. The apparatus as claimed in claim 6, wherein the apparatus caused to perform encoding the at least one energy ratio value for the at least one sub-frame of each sub-band of a frame of the audio signal is caused to perform:
generating a weighted average of the at least one energy ratio value; and
encoding the weighted average of the at least one energy ratio value.

11. The apparatus as claimed in claim 10, wherein the apparatus caused to perform encoding the weighted average of the at least one energy ratio value is further caused to perform scalar non-uniform quantizing the at least one weighted average of the at least one energy ratio value.

12. The apparatus as claimed in claim 1, wherein the at least one entropy encoding is Golomb Rice encoding.

13. The apparatus as claimed in claim 1, wherein the apparatus is further caused to perform: storing and/or transmitting the encoded at least one directional value.

14. A method comprising:
obtaining values for parameters representing an audio signal, the values comprising at least one directional value and at least one energy ratio value for at least one sub-frame of each sub-band of a frame of the audio signal;
obtaining an allowed number of bits for encoding the at least one directional value and the at least one energy ratio value for the at least one sub-frame of each sub-band of the frame of the audio signal;
encoding the at least one directional value for the at least one sub-frame of each sub-band of the frame based on at least one resolution entropy encoding, wherein one of the at least one resolution entropy encoding is further for:
first resolution entropy encoding the at least one directional value and determining the number of bits used encoding the at least one directional value based on the first entropy encoding;
first resolution entropy encoding at least one reduced directional value and determining the number of bits used encoding the at least one reduced directional value based on the first entropy encoding;
selecting the first resolution entropy encoding of the at least one directional value when the number of bits used encoding the at least one directional value based on the first resolution entropy encoding is less than or equal to a portion of the allowed number of bits for encoding the at least one directional value; and
selecting the first resolution entropy encoding of the at least one reduced directional value when the number of bits used encoding the at least one directional value based on the first resolution entropy encoding is more than the portion of the allowed number of bits for encoding the at least one directional value and the number of bits used encoding the at least one directional value based on the first resolution entropy encoding is less than or equal to the portion of the allowed number of bits for encoding the at least one directional value.

15. The method as claimed in claim 14, wherein first resolution entropy encoding the at least one directional value and determining the number of bits used encoding the at least one directional value based on the first entropy encoding comprises at least one resolution entropy encoding of at least one value determined from a difference from the at least one directional value compared to an average directional value for the frame and determining a number of bits used encoding the at least one value, and first resolution entropy encoding at least one reduced directional value and determining the number of bits used encoding the at least one reduced directional value based on the first entropy encoding comprises at least one resolution entropy encoding of at least one reduced value from a reduced difference based on the difference between the at least one directional value compared to the average directional value for the frame and determining a number of bits used encoding the at least one reduced value.

16. The method as claimed in claim 14, wherein encoding the at least one directional value for at least one sub-frame of each sub-band of a frame based on at least one resolution entropy encoding comprises:
second resolution entropy encoding at least one value based on the at least one directional value and determining the number of bits used encoding the at least one value based on the second resolution entropy encoding, wherein the second resolution entropy encoding is a lower resolution encoding than the first resolution entropy encoding and exploits similarities between time-frequency tiles within a sub-band within the frame when the frame comprises more than one time-frequency tile within a sub-band; and
selecting the second resolution entropy encoding of the at least one value when the number of bits used encoding the at least one value based on the second resolution entropy encoding is less than or equal to the portion of the allowed number of bits for encoding the at least one directional value.

17. The method as claimed in claim 16, wherein the at least one value based on the at least one directional value is at least one difference value from the at least one directional value compared to an average directional value for the frame.

18. The method as claimed in claim 16, wherein the method further comprises selecting the second resolution entropy encoding of the at least one value based on the at least one directional value when the number of bits used encoding the at least one value based on the second resolution entropy encoding is greater than the portion of the allowed number of bits for encoding the at least one directional value but is less than a determined relaxed number of bits.

19. The method as claimed in claim 18, wherein the relaxed number of bits is a number of bits relative to the portion of the allowed number of bits for encoding the at least one directional value.

20. The method as claimed in claim 18, wherein encoding the at least one directional value for the at least one sub-frame of each sub-band of the frame based on at least one resolution entropy encoding, wherein one of the at least one resolution entropy encoding further comprises:
third resolution entropy encoding at least one value based on the at least one directional value and determining the number of bits used encoding the at least one value based on the third resolution entropy encoding, wherein the quantization resolution of the third resolution is lower than the first and second resolution entropy encoding; and
selecting the third resolution entropy encoding of the at least one value based on the at least one directional value when the number of bits used encoding the at least one value based on the first or second resolution entropy encoding is more than the portion of the allowed number of bits for encoding the at least one value.
